(19) United States
(12) Patent Application Publication
(10) Pub. No.: US 2019/0152212 A1
(43) Pub. Date: May 23, 2019

(54) MANUFACTURING METHOD OF THERMOPLASTIC CONTINUOUS-DISCONTINUOUS FIBER COMPOSITE SHEET

(71) Applicant: Swancor Ind. Co., Ltd., Nantou County (TW)

(72) Inventors: Yu-Tsan Tseng, Nantou County (TW); Li-Chu Wu, Nantou County (TW)

(73) Assignee: Swancor Ind. Co., Ltd., Nantou County (TW)

(21) Appl. No.: 15/893,670

(22) Filed: Feb. 11, 2018

(30) Foreign Application Priority Data
Nov. 22, 2017 (TW) 106140622

(51) Int. Cl. B32B 37/18; B29C 65/70; B29C 65/18; B29C 65/00; B29C 45/00; B32B 27/14; B32B 27/08; B32B 27/20; B29C 69/00

(52) U.S. Cl. CPC B32B 37/182; B29C 65/70; B29C 65/18; B29C 66/72141; B29C 66/72143; B29C 45/0005; B29K 2105/08; B32B 27/08; B32B 27/20; B29C 69/001; B32B 2272/00; B32B 2305/70; B32B 27/14

(57) ABSTRACT

A manufacturing method of a thermoplastic continuous-discontinuous fiber composite sheet is provided, including providing a thermoplastic composite including a continuous fiber and a first thermoplastic resin. A mechanical treatment is performed on the thermoplastic composite to form a plurality of fragments such that the continuous fiber is changed into a discontinuous fiber. At least one thermoplastic discontinuous fiber aggregate layer is formed using the plurality of fragments as a raw material. The at least one thermoplastic discontinuous fiber aggregate layer is thermally compressed with at least one thermoplastic continuous fiber layer.

### CROSS-REFERENCE TO RELATED APPLICATION

This application claims the priority benefit of Taiwan application serial no. 106140622, filed on Nov. 22, 2017. The entirety of the above-mentioned patent application is hereby incorporated by reference herein and made a part of this specification.

### BACKGROUND OF THE INVENTION

### Field of the Invention

The invention relates to a multi-layer composite sheet manufacturing method, and more particularly, to a manufacturing method of a thermoplastic continuous-discontinuous fiber composite sheet.

### Description of Related Art

A fiber-reinforced sheet formed by a matrix resin and a reinforcing fiber has good mechanical properties, is lightweight, and resistant to corrosion, and is therefore extensively applied in the material of components of, for instance, aircraft, automobiles, and sports equipment.

The current thermoplastic continuous fiber sheet is mostly formed by thennally compressing a plurality layer of a continuous fiber cloth and a thermoplastic polymer, and in comparison to a traditional thermosetting continuous fiber material, the features of rapid molding and recyclability are achieved, but significant drawbacks still exist in actual use.

In terms of recycling, the current recycling containing a thermoplastic continuous fiber material mostly adopts a pyrolysis method and a high-temperature furnace is needed to maintain a suitable temperature, a polymer is selectively pyrolyzed, and the fiber is left. Although this method can retain the maximum fiber length, the process energy consumption is high, and during the pyrolysis, the sizing of the fiber surface is broken down at the same time, thus affecting the subsequent fiber reusability in resin impregnation. Moreover, the polymer and fiber are separated using a solvent, which not only consumes solvent, but also requires energy to separate the solvent and the polymer, thus causing more environmental issues.

Another recycling and reuse method includes mixing and granulating a recycled continuous fiber substrate (such as byproducts of a continuous fiber substrate) and a thermoplastic resin and using the particles as a raw material for an injection process. This method has low technical requirements and is time-tested, and is easy to use. However, when injection molding is directly performed, fiber of byproducts cannot be sufficiently dispersed in a thermoplastic resin. Moreover, via screw mixing and granulation and screw melting of an injection machine followed by high-pressure shear promotion, after going through a runner injection mold, the fiber length in the material is significantly reduced, and mechanical enhancements are limited. Therefore, JP2006-218793 discloses crushing and granulating a carbon fiber-reinforced thermoplastic resin molded product and then mixing with a new carbon fiber-reinforced thermoplastic resin particle and performing injection molding. However, production cost is increased as a result.

Moreover, WO 2012086682 A1 (CN 103119209 A, EP 2642007 A1, and US 20130192434) discloses a method of manufacturing a carbon fiber-reinforced plastic. In the method, byproducts of a carbon fiber substrate containing carbon fiber are cut, and the resulting cut pieces are added in a thermoplastic resin fiber during a carding process to obtain a carbon fiber aggregate containing a thermoplastic resin fiber. Next, the carbon fiber aggregate containing a thermoplastic resin fiber is immersed in a matrix resin and molded to obtain a carbon fiber-reinforced plastic. However, the carbon fiber aggregate obtained by the method above still requires a dipping process, and the time required is long, and reusability and environmental friendliness are poor.

Moreover, in comparison to a thermosetting continuous fiber material, the formability of the traditional continuous fiber thermoplastic material is very poor, and a component with complex geometric structure cannot be formed. In particular, the formability of the portion with greater curvature of a sheet with large thickness is very poor, and wrinkles readily occur. The thermoplastic carbon fiber sheet has a relatively small application scope due to low forming complexity.

However, to achieve a multi-layer carbon fiber composite sheet with large thickness, the surface layer is a continuous carbon fiber and the intermediate core layer is mostly a honeycomb structure or a foaming material, but secondary forming is not possible for this method, material utilization is low, and material cost cannot be effectively reduced.

### SUMMARY OF THE INVENTION

The invention provides a manufacturing method of a thermoplastic continuous-discontinuous fiber composite sheet that can achieve a thermoplastic continuous-discontinuous fiber composite sheet with good flexural properties and formability.

The manufacturing method of the thermoplastic continuous-discontinuous fiber composite sheet of the invention includes providing a thermoplastic composite, wherein the theinioplastic composite includes a continuous fiber and a first thermoplastic resin; performing a mechanical treatment on the thermoplastic composite to form a plurality of fragments, such that the continuous fiber is changed into a discontinuous fiber; forming at least one thermoplastic discontinuous fiber aggregate layer using the plurality of fragments as a raw material; and thermally compressing the at least one thermoplastic discontinuous fiber aggregate layer and the at least one thermoplastic continuous fiber layer.

In an embodiment of the invention, the step of thermally compressing the at least one thermoplastic discontinuous fiber aggregate layer and the at least one thermoplastic continuous fiber layer can include overlapping the thermoplastic discontinuous fiber aggregate layer and the two thermoplastic continuous fiber layer and performing thermal compression such that the thermoplastic discontinuous fiber aggregate layer is clamped between the two thermoplastic continuous fiber layers.

In an embodiment of the invention, the step of thermally compressing the at least one thermoplastic discontinuous fiber aggregate layer and the at least one thermoplastic continuous fiber layer can include overlapping the thell ioplastic continuous fiber layer and the two thermoplastic discontinuous fiber aggregate layer and performing thermal compression such that the thermoplastic continuous fiber layer is clamped between the two thermoplastic discontinuous fiber aggregate layers.

In an embodiment of the invention, the step of thermally compressing the at least one thermoplastic discontinuous fiber aggregate layer and the at least one thermoplastic continuous fiber layer includes alternately overlapping the thermoplastic continuous fiber layer and the thermoplastic discontinuous fiber aggregate layer and performing thermal compression.

In an embodiment of the invention, before thermally compressing the at least one theiinoplastic discontinuous fiber aggregate layer and the at least one thermoplastic continuous fiber layer, a strengthening layer can further be formed on at least one surface of the thermoplastic discontinuous fiber aggregate layer, wherein the strengthening layer is at least located between the thermoplastic discontinuous fiber aggregate layer and the thermoplastic continuous fiber layer.

In an embodiment of the invention, the strengthening layer is, for instance, formed by a single film layer or a powder.

In an embodiment of the invention, the method of forming the thermoplastic discontinuous fiber aggregate layer can include thermally compressing the plurality of fragments.

In an embodiment of the invention, the method of thermally compressing the plurality of fragments is, for instance, molding or stamping.

In an embodiment of the invention, the method of forming the thermoplastic discontinuous fiber aggregate layer can include mixing and granulating the plurality of fragments to form a plurality of particles; and performing injection molding using the plurality of particles.

In an embodiment of the invention, the method of thermally compressing the thermoplastic discontinuous fiber aggregate layer and the thermoplastic continuous fiber layer includes laminating using a flat film or a flat steel sheet.

In an embodiment of the invention, the continuous fiber in the thermoplastic composite is, for instance, carbon fiber, glass fiber, basalt fiber, metal fiber, ceramic fiber, or chemical fiber.

In an embodiment of the invention, the first thermoplastic resin in the thermoplastic composite is, for instance, polycarbonate (PC), polypropylene (PP), polysulfone (PS), thermoplastic polyurethane (TPU), acrylonitrile butadiene styrene resin (ABS), polyethylene (PE), thermoplastic epoxy resin, polyurethane resin, polyurea resin, or a combination thereof.

In an embodiment of the invention, the strengthening layer includes a second thermoplastic resin.

In an embodiment of the invention, the second thermoplastic resin includes polycarbonate, polypropylene, polysulfone, thermoplastic polyurethane, acrylonitrile-butadiene-styrene resin, polyethylene, thermoplastic epoxy resin, polyurethane resin, polyurea resin, or a combination thereof.

In an embodiment of the invention, the first thermoplastic resin is different from the second thermoplastic resin.

In an embodiment of the invention, the length of the discontinuous fiber is 3 mm to 20 mm.

In an embodiment of the invention, the length of the discontinuous fiber is less than 3 mm.

In an embodiment of the invention, the length of the discontinuous fiber is 20 mm to 50 mm.

In an embodiment of the invention, the thermoplastic composite is a recycled thermoplastic composite.

Based on the above, the thermoplastic continuous-discontinuous fiber composite sheet of the invention has a structure formed by a thermoplastic continuous fiber layer and a thermoplastic non-continuous fiber aggregate layer, and therefore has good flexural properties and formability.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross section of a thermoplastic continuous-discontinuous fiber composite sheet of the first embodiment of the invention.

FIG. 2 is a cross section of a thermoplastic continuous-discontinuous fiber composite sheet of the second embodiment of the invention.

FIG. 3 is a cross section of a thermoplastic continuous-discontinuous fiber composite sheet of the third embodiment of the invention.

FIG. 4 is a cross section of a thermoplastic continuous-discontinuous fiber composite sheet of the fourth embodiment of the invention.

FIG. 5 is a cross section of a thermoplastic continuous-discontinuous fiber composite sheet of the fifth embodiment of the invention.

FIG. 6 is a cross section of a thermoplastic continuous-discontinuous fiber composite sheet of the sixth embodiment of the invention.

FIG. 7 shows the steps of a manufacturing process of a thermoplastic continuous-discontinuous fiber composite sheet according to the first embodiment of the invention.

FIG. 8A is a cross section of a thermoplastic discontinuous fiber aggregate layer of the first embodiment.

FIG. 8B is a cross section of another thermoplastic discontinuous fiber aggregate layer of the first embodiment.

FIG. 9 is a cross section of a thermoplastic continuous-discontinuous fiber composite sheet of an embodiment of the invention.

### DESCRIPTION OF THE EMBODIMENTS

Some embodiments are provided hereinafter and described in detail with reference to figures. However, the embodiments provided are not intended to limit the scope of the invention. Moreover, the figures are only descriptive and are not drawn to scale. For ease of explanation, the same devices below are provided with the same reference numerals. Moreover, terms such as “contain”, “include”, and “have” used in the specification are all open terms, i.e., contains, but not limited to. Moreover, directional terms used in the specification such as “up” and “down” are only directions used in the figures. Therefore, the directional terms are used to illustrate and are not intended to limit the invention.

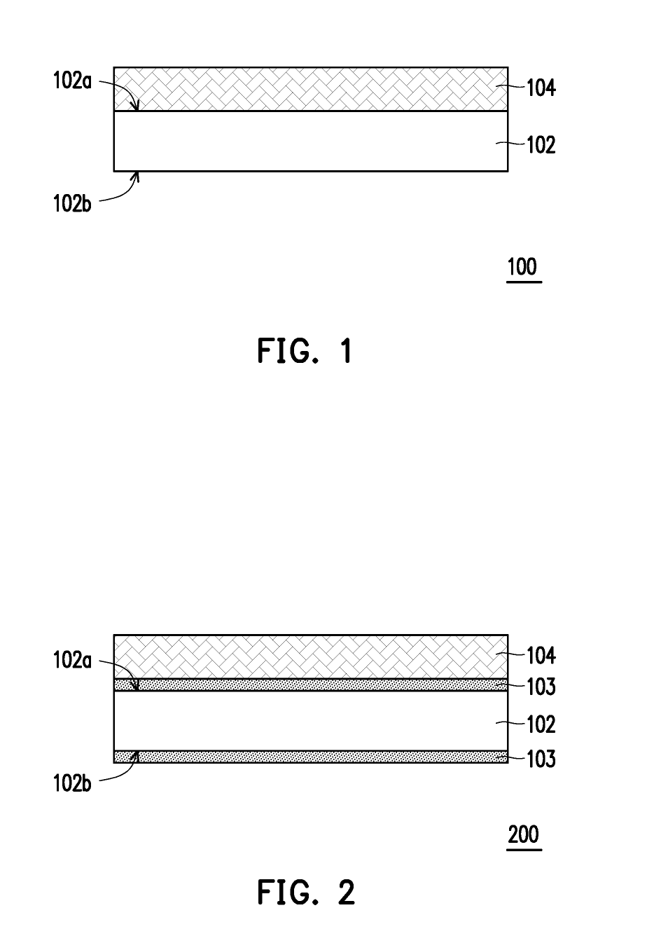

FIG. 1 is a cross section of a thermoplastic continuous-discontinuous fiber composite sheet of the first embodiment of the invention.

Referring to FIG. 1, a thermoplastic continuous-discontinuous fiber composite sheet 100 includes a thermoplastic discontinuous fiber aggregate layer 102 and a thermoplastic continuous fiber layer 104 that are alternately stacked. The thermoplastic discontinuous fiber aggregate layer 102 includes a discontinuous fiber and a first thermoplastic resin. In an embodiment, the discontinuous fiber in the thermoplastic discontinuous fiber aggregate layer 102 is, for instance, carbon fiber, glass fiber, basalt fiber, metal fiber, ceramic fiber, or chemical fiber; the first thermoplastic resin in the thermoplastic discontinuous fiber aggregate layer 102 is, for instance, polycarbonate (PC), polypropylene (PP), polysulfone (PS), thermoplastic polyurethane (TPU), acrylonitrile butadiene styrene resin (ABS), polyethylene (PE), thermoplastic epoxy resin, polyurethane resin, polyurea resin, or a combination thereof. In an embodiment, the raw material of the thermoplastic discontinuous fiber aggregate layer 102 is, for instance, fragments of recycled thermoplastic composite, wherein the thermoplastic composite includes continuous fiber and thermoplastic resin. Specifically, a mechanical treatment can be performed on the recycled thermoplastic composite to form fragments and change the continuous fiber in the recycled thermoplastic composite into discontinuous fiber.

In an embodiment, the length of the discontinuous fiber in the thermoplastic discontinuous fiber aggregate layer 102 is 3 mm to 20 mm. In another embodiment, the length of the discontinuous fiber in the thermoplastic discontinuous fiber aggregate layer 102 is less than 3 mm. In yet another embodiment, the length of the discontinuous fiber in the thermoplastic discontinuous fiber aggregate layer 102 is 20 mm to 50 mm.

The thermoplastic continuous fiber layer 104 includes a continuous fiber and a second thermoplastic resin. In an embodiment, the continuous fiber in the thermoplastic continuous fiber layer 104 is, for instance, a material such as carbon fiber, glass fiber, basalt fiber, metal fiber, ceramic fiber, or other chemical fibers; the second thermoplastic resin in the thermoplastic continuous fiber layer 102 is, for instance, polycarbonate, polypropylene, polysulfone, thermoplastic polyurethane, acrylonitrile-butadiene-styrene resin, polyethylene, thermoplastic epoxy resin, polyurethane resin, polyurea resin, or a combination thereof. In an embodiment, the thermoplastic continuous fiber layer 104 is, for instance, a continuous fiber cloth impregnated by a thermoplastic resin.

The thermoplastic continuous-discontinuous fiber composite sheet 100 has a structure formed by a thermoplastic continuous fiber layer and a thermoplastic discontinuous fiber aggregate layer, and therefore has good flexural properties and formability.

FIG. 2 is a cross section of a thermoplastic continuous-discontinuous fiber composite sheet of the second embodiment of the invention. In the present embodiment, a thermoplastic continuous-discontinuous fiber composite sheet 200 further includes a strengthening layer 103. The strengthening layer 103 is respectively disposed on a first surface 102a and a second surface 102b of the thermoplastic discontinuous fiber aggregate layer 102 opposite to each other. In an embodiment, the strengthening layer 103 is, for instance, formed by a single film layer or a powder. In an embodiment, the material of the strengthening layer 103 includes a third thermoplastic resin. The third thermoplastic resin is, for instance, polycarbonate, polypropylene, polysulfone, thermoplastic polyurethane, acrylonitrile-butadiene-styrene resin, polyethylene, thermoplastic epoxy resin, polyurethane resin, polyurea resin, or a combination thereof. In the present embodiment, the strengthening layer 103 is disposed on opposite surfaces (i.e., the first surface 102a and the second surface 102b) of the thermoplastic discontinuous fiber aggregate layer 102, but the invention is not limited thereto. In another embodiment, the strengthening layer 103 can be disposed only between the thermoplastic discontinuous fiber aggregate layer 102 and the thermoplastic continuous fiber layer 104.

In general, the stacking between fibers may produce spaces, such that mechanical strength is reduced. In the present embodiment, since the strengthening layer 103 is formed between the thermoplastic discontinuous fiber aggregate layer 102 and the thermoplastic continuous fiber layer 104, the strengthening layer 103 can be filled to level the space between the thermoplastic discontinuous fiber aggregate layer 102 and the thermoplastic continuous fiber layer 104 to enhance the overall mechanical properties of the resulting product. Moreover, if the surface of the thermoplastic discontinuous fiber aggregate layer 102 is a smooth surface, then the surface can also be modified to increase the bonding between the thermoplastic discontinuous fiber aggregate layer and the subsequent structural layer using the thermoplastic resin different from the thermoplastic resin in the thermoplastic discontinuous fiber aggregate layer 102. Moreover, the thermoplastic fiber layer is generally bonded with a regular engineering plastic (a different type of material), but the thermoplastic fiber layer cannot satisfy the lamination of all of the different types of materials. In the present embodiment, since the strengthening layer 103 is formed on the surface of the thermoplastic discontinuous fiber aggregate layer 102, interface modification can be performed on the surface of the thermoplastic discontinuous fiber aggregate layer 102 via the strengthening layer 103 to increase the bonding of different types of materials.

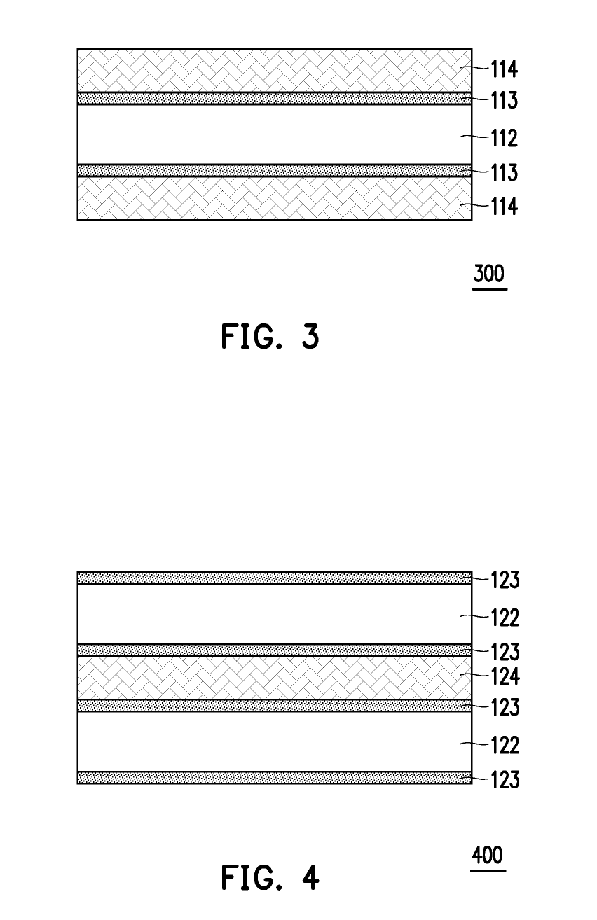

FIG. 3 is a cross section of a thermoplastic continuous-discontinuous fiber composite sheet of the third embodiment of the invention. In the present embodiment, a thermoplastic continuous-discontinuous fiber composite sheet 300 includes a thermoplastic discontinuous fiber aggregate layer 112 and two thermoplastic continuous fiber layers 114, wherein the two thermoplastic continuous fiber layers 114 are respectively disposed on opposite surfaces of the thermoplastic discontinuous fiber aggregate layer 112. Moreover, in the present embodiment, the strengthening layer 113 is formed on opposite surfaces of the thermoplastic discontinuous fiber aggregate layer 112, and the strengthening layer 113 is disposed between the thermoplastic discontinuous fiber aggregate layer 112 and the thermoplastic continuous fiber layer 114.

FIG. 4 is a cross section of a thermoplastic continuous-discontinuous fiber composite sheet of the fourth embodiment of the invention. In the present embodiment, a thermoplastic continuous-discontinuous fiber composite sheet 400 includes two thermoplastic discontinuous fiber aggregate layers 122 and a thermoplastic continuous fiber layer 124, wherein the two thermoplastic discontinuous fiber aggregate layers 122 are respectively disposed on opposite surfaces of the thermoplastic continuous fiber layer 124. Moreover, in the present embodiment, a strengthening layer 123 is formed on opposite surfaces of each of the thermoplastic discontinuous fiber aggregate layers 122, but the invention is not limited thereto. In another embodiment, the strengthening layer 123 can be disposed only on the surface of the thermoplastic discontinuous fiber aggregate layers 122 facing the thermoplastic continuous fiber layer 124.

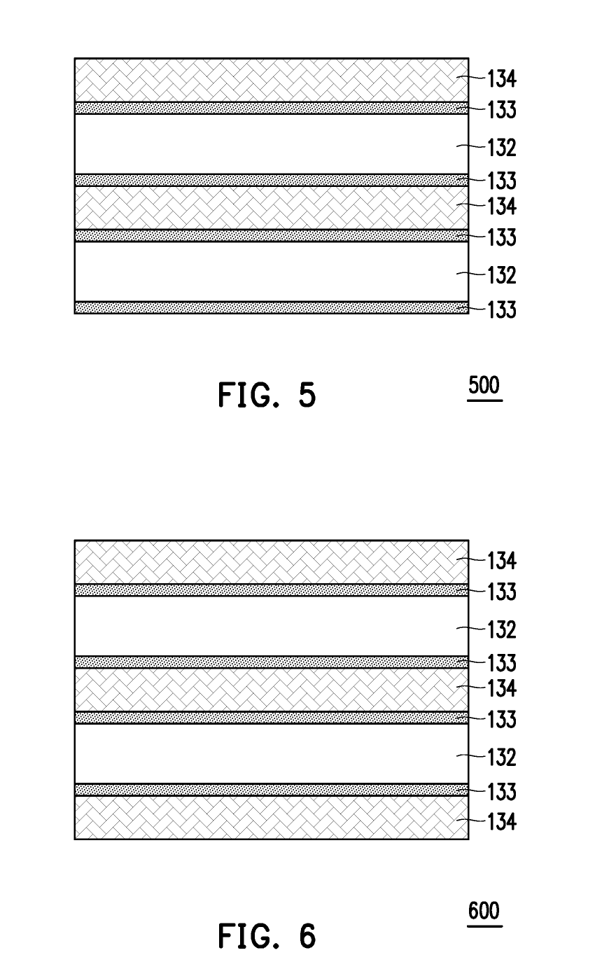

FIG. 5 is a cross section of a thermoplastic continuous-discontinuous fiber composite sheet of the fifth embodiment of the invention. In the present embodiment, a thermoplastic continuous-discontinuous fiber composite sheet 500 includes a plurality of thermoplastic discontinuous fiber aggregate layers and a plurality of thermoplastic continuous fiber layers. Specifically, the thermoplastic continuous-discontinuous fiber composite sheet 500 includes two thermoplastic discontinuous fiber aggregate layers 132 and two thermoplastic continuous fiber layers 134, wherein the thermoplastic discontinuous fiber aggregate layers 132 and the thermoplastic continuous fiber layers 134 are alternately stacked. In the present embodiment, a strengthening layer 133 is formed on both of the opposite surfaces of each of the thermoplastic discontinuous fiber aggregate layers 132, but the invention is not limited thereto. In another embodiment, the strengthening layer 133 can be disposed only on the surface of each of the thermoplastic discontinuous fiber aggregate layers 132 facing the thermoplastic continuous fiber layer 134.

FIG. 6 is a cross section of a thermoplastic continuous-discontinuous fiber composite sheet of the sixth embodiment of the invention. In the present embodiment, the outermost layers are all thermoplastic continuous fiber layers 134 to form a sheet with better strength. The quantity and size of the thermoplastic discontinuous fiber aggregate layer and the thermoplastic continuous fiber layer can both be changed as needed and are not limited to the embodiments above. Moreover, a strengthening layer is formed on the surface of the thermoplastic discontinuous fiber aggregate layer in all of the embodiments above, but the invention is not limited thereto, and a strengthening layer can also not be formed.

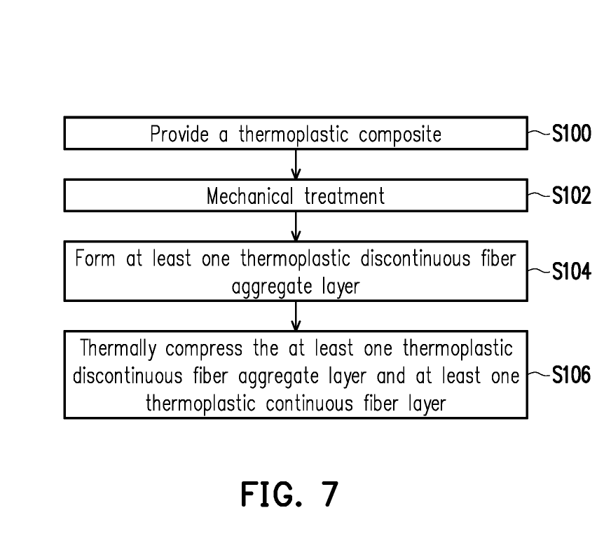

FIG. 7 shows the steps of a manufacturing process of a thermoplastic continuous-discontinuous fiber composite sheet according to the first embodiment of the invention. Referring to FIG. 1 and FIG. 7, in the following, the manufacturing method of the thermoplastic continuous-discontinuous fiber composite sheet of the present embodiment is described with reference to the thermoplastic continuous-discontinuous fiber composite sheet of FIG. 1.

Referring to FIG. 7, in step S100, a thermoplastic composite is provided, wherein the thermoplastic composite includes a continuous fiber and a thermoplastic resin. In an embodiment, the thermoplastic composite is a recycled thermoplastic composite. Since the thermoplastic composite produces many byproducts and process waste of different sizes during molding, the recycled byproducts and process waste are used as raw materials for the thermoplastic discontinuous fiber aggregate layer of the invention for secondary molding, so as to significantly reduce cost and increase material utilization and achieve good environmental protection. Moreover, high-energy combustion or pickling is required for the recycling of thermoset composite as the raw material, and therefore in comparison to using a thermoset composite as the raw material, in the present embodiment, the use of a thermoplastic composite as the raw material has the advantage of energy-saving and carbon reduction. Moreover, in comparison to using dry yarn prior to impregnation as the raw material, in the present embodiment, impregnated thermoplastic composite is used as the raw material, and therefore the resulting product has good impregnation properties.

Next, in step S102, a mechanical treatment is performed on the thermoplastic composite to form a plurality of fragments such that the continuous fiber is changed into a discontinuous fiber. In an embodiment, the mechanical treatment includes crushing the recycled thermoplastic composite having a fiber length less than 20 mm. In another embodiment, the mechanical treatment includes shredding the recycled thermoplastic composite having a fiber length of 20 mm or more with a shredder. The fragments from the mechanical treatment can include short fibers, long fibers, or super-long fibers. For instance, the fragments obtained from crushing are, for instance, short fibers with a fiber length of less than 5 mm or long fibers with a fiber length of 5 mm to 20 mm; and the fragments obtained from shredding are, for instance, super-long fibers with a fiber length greater than 20 mm.

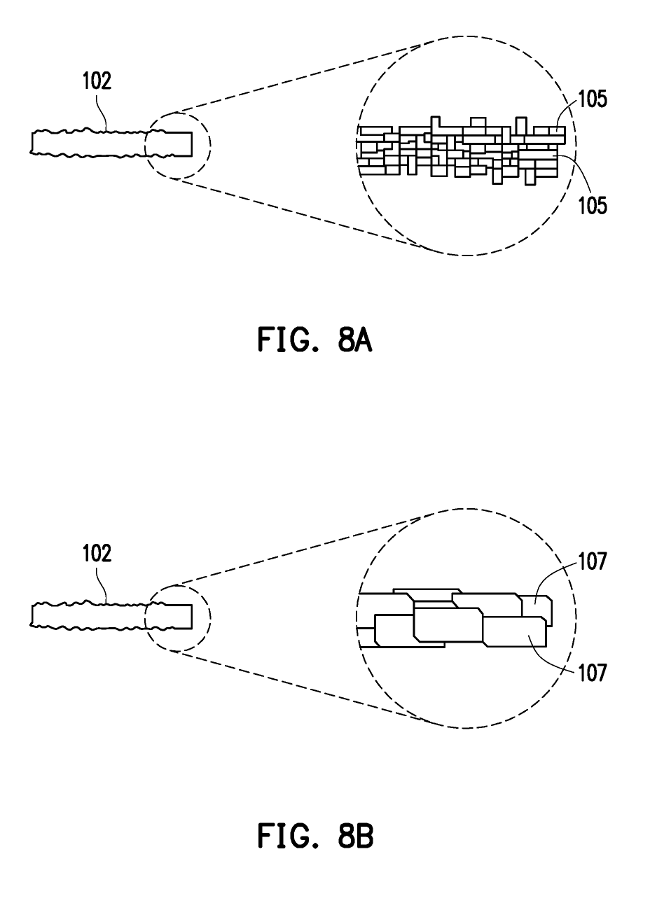

Next, in step S104, at least one thermoplastic discontinuous fiber aggregate layer 102 is formed by directly using the fragments as a raw material. In an embodiment, the method of forming the thermoplastic discontinuous fiber aggregate layer 102 can include mixing and granulating the fragments to form a plurality of particles and then performing injection molding using the particles as shown in FIG. 8A. In another embodiment, the method of forming the thermoplastic discontinuous fiber aggregate layer 102 includes thermally compressing the fragments such as molding or stamping as shown in FIG. 8B.

Next, in step S106, the at least one thermoplastic discontinuous fiber aggregate layer 102 is thermally compressed with at least one thermoplastic continuous fiber layer 104. The method of thermally compressing the thermoplastic discontinuous fiber aggregate layer 102 and the thermoplastic continuous fiber layer 104 includes laminating using, for instance, a flat film or a flat steel sheet. At this point, the thermoplastic continuous-discontinuous fiber composite sheet 100 of the invention is complete.

The thermoplastic continuous-discontinuous fiber composite sheet 100 has a structure formed by a thermoplastic continuous fiber layer and a thermoplastic non-continuous fiber aggregate layer, and therefore has good flexural properties and formability.

In FIG. 8A, the thermoplastic discontinuous fiber aggregate layer 102 is formed by particles 105, and spaces are observed on the magnified surface of the thermoplastic discontinuous fiber aggregate layer 102, and therefore the surface is not very smooth. In FIG. 8B, the thermoplastic discontinuous fiber aggregate layer 102 is formed by stacking the fragments 107, and the magnified surface of the thermoplastic discontinuous fiber aggregate layer 102 is also not very smooth.

Therefore, in an embodiment, before step S106 is performed, the strengthening layer 103 can be formed on at least one surface of the thermoplastic discontinuous fiber aggregate layer 102. Next, thermal compression is performed such that the strengthening layer 103 is at least located between the thermoplastic discontinuous fiber aggregate layer 102 and the thermoplastic continuous fiber layer 104. Since the strengthening layer 103 is formed between the thermoplastic discontinuous fiber aggregate layer 102 and the thermoplastic continuous fiber layer 104, the strengthening layer 103 can be filled to level the space between the thermoplastic discontinuous fiber aggregate layer 102 and the thermoplastic continuous fiber layer 104 to enhance the overall mechanical properties of the resulting product. Moreover, in the present embodiment, the strengthening layer 103 is formed on opposite surfaces (i.e., the first surface 102a and the second surface 102b) of the thermoplastic discontinuous fiber aggregate layer 102 as shown in FIG. 2, but the invention is not limited thereto. In another embodiment, the strengthening layer 103 can be only formed on the surface of the thermoplastic discontinuous fiber aggregate layer 122 facing the thermoplastic continuous fiber layer 124, that is, the strengthening layer 103 can be only formed between the thermoplastic discontinuous fiber aggregate layer 102 and the thermoplastic continuous fiber layer 104.

In an embodiment, the step of thermally compressing the at least one thermoplastic discontinuous fiber aggregate layer and the at least one thermoplastic continuous fiber layer can include first overlapping a thermoplastic discontinuous fiber aggregate layer and two thermoplastic continuous fiber layers and performing thermal compression such that the thermoplastic discontinuous fiber aggregate layer 112 of the thermoplastic continuous-discontinuous fiber composite sheet 300 is clamped between two thermoplastic continuous fiber layers 114 as shown in FIG. 3.

In an embodiment, the step of thermally compressing the at least one thermoplastic discontinuous fiber aggregate layer and the at least one thermoplastic continuous fiber layer can include overlapping a thermoplastic continuous fiber layer and two thermoplastic discontinuous fiber aggregate layers and then performing thermal compression such that the thermoplastic continuous fiber layer 124 of the thermoplastic continuous-discontinuous fiber composite sheet 400 is clamped between two thermoplastic discontinuous fiber aggregate layers 122 as shown in FIG. 4.

In an embodiment, the step of thermally compressing the at least one thermoplastic discontinuous fiber aggregate layer and the at least one thermoplastic continuous fiber layer includes: alternately overlapping the thermoplastic continuous fiber layer and the thermoplastic discontinuous fiber aggregate layer and performing thermal compression to obtain the thermoplastic continuous-discontinuous fiber composite sheet shown in FIG. 5 or FIG. 6.

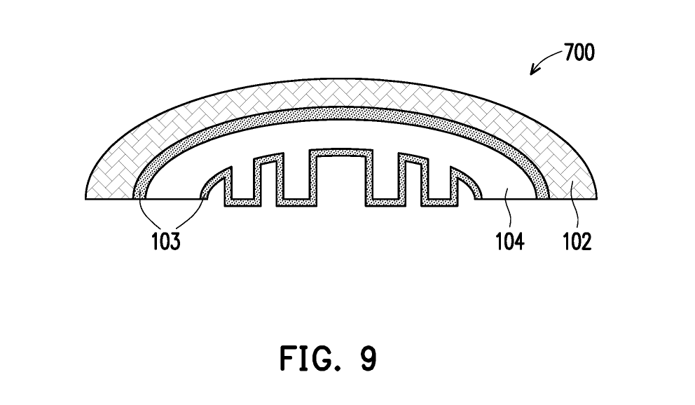

Moreover, in other embodiments, a thermoplastic discontinuous fiber aggregate layer 102 and a thermoplastic continuous fiber layer 104 with different sizes can be selected for thermal compression to form a thermoplastic continuous-discontinuous fiber composite sheet 700 of the complex structure of FIG. 9. The quantity and size of the thermoplastic discontinuous fiber aggregate layer and the thermoplastic continuous fiber layer can both be changed as needed and are not limited to the embodiments above.

Several experimental examples are described below to verify the efficacy of the invention. However, the invention is not limited to the following content.

### Experimental Example 1

First, a thermoplastic composite having a carbon fiber with a fiber length less than 20 mm was crushed to obtain fragments with a fiber length of 3 mm to 20 mm (i.e., crushed material). Next, the crushed material was mixed and granulated, that is, fresh plastic material was added for mixing to produce particles (fiber length less than 3 mm), and then injection molding was performed using the particles to obtain a thermoplastic discontinuous fiber aggregate layer. Next, the thermoplastic discontinuous fiber aggregate layer and two layers of 3K prepreg cloth (i.e., thermoplastic continuous fiber layers) were thermally compressed, wherein the 3K prepreg cloth refers to a prepreg cloth formed by weaving a 3K carbon yarn in half warp and half weft. The resulting structure is a sandwich structure of thermoplastic continuous fiber layer/thermoplastic discontinuous fiber aggregate structure/thermoplastic continuous fiber layer with thermoplastic continuous fiber layer as the upper and lower outer layers.

### Experimental Example 2

First, a thermoplastic composite having a carbon fiber with a fiber length less than 20 mm was crushed to obtain fragments with a fiber length of 3 mm to 20 mm (i.e., crushed material). Next, the crushed material was thermally compressed to form a thermoplastic discontinuous fiber aggregate layer.

### Experimental Example 3

First, a thermoplastic composite having a carbon fiber with a fiber length of 20 mm or more was shredded by a shredder to obtain fragments with a fiber length of 20 mm to 50 mm (crushed material). Next, the crushed material was thermally compressed to form a thermoplastic discontinuous fiber aggregate layer.

Control Group

Three layers of unidirectional prepreg cloth and two layers of 3K prepreg cloth were thermally compressed, wherein the unidirectional prepreg cloth and the 3K prepreg cloth are both thermoplastic continuous fiber layers.

Next, a mechanical strength test and an estimate in the decline of mechanical properties and cost were respectively performed on experimental examples 1 to 3 and a control group, and the results are shown in Table 1 below. It should be mentioned that, all of the measurement data is based on the same thickness and the 3K prepreg cloth used are all the same.

TABLE 1

| | | | Average | Average | Decline in | |
|---|---|---|---|---|---|---|
| | | | flexural | flexural | mechanical | Cost |
| | Sheet stack | Density | strength | modulus | property | reduction |
| | configuration | (g/cm³) | (MPa) | (GPa) | (%) | (%) |
| Experimental | Thermoplastic | 1.24 | 572.63 | 36.4 | 45 | 32 |
| example 1 | continuous fiber | | | | | |
| | layer/thermoplastic | | | | | |
| | discontinuous | | | | | |
| | fiber aggregate | | | | | |
| | layer/thermoplastic | | | | | |
| | continuous fiber | | | | | |
| | layer | | | | | |
| Experimental | Thermoplastic | 1.53 | 711.81 | 47.0 | 30 | 35 |
| example 2 | continuous fiber | | | | | |
| | layer/thermoplastic | | | | | |
| | discontinuous | | | | | |
| | fiber aggregate | | | | | |
| | layer/thermoplastic | | | | | |
| | continuous fiber | | | | | |
| | layer | | | | | |
| Experimental | Thermoplastic | 1.54 | 744.17 | 50.7 | 25 | 35 |
| example 3 | continuous fiber | | | | | |
| | layer/thermoplastic | | | | | |
| | discontinuous | | | | | |
| | fiber aggregate | | | | | |
| | layer/thermoplastic | | | | | |
| | continuous fiber | | | | | |
| | layer | | | | | |
| Control | Thermoplastic | 1.53 | 988.52 | 67.3 | — | — |
| group | continuous fiber | | | | | |
| | layer | | | | | |

It can be seen from Table 1 that, experimental examples 1 to 3 can achieve the effects of 32% to 35% lower cost and maintaining different degrees of mechanical strengths, and material utilization is increased to 99%.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A manufacturing method of a thermoplastic continuous-discontinuous fiber composite sheet, comprising:
providing a thermoplastic composite, wherein the thermoplastic composite comprises a continuous fiber and a first thermoplastic resin;
performing a mechanical treatment on the thermoplastic composite to form a plurality of fragments such that the continuous fiber is changed into a discontinuous fiber;
forming at least one thermoplastic discontinuous fiber aggregate layer using the plurality of fragments as a raw material; and
thermally compressing the at least one thermoplastic discontinuous fiber aggregate layer and at least one thermoplastic continuous fiber layer.

2. The manufacturing method of the thermoplastic continuous-discontinuous fiber composite sheet of claim 1, wherein the step of thermally compressing the at least one thermoplastic discontinuous fiber aggregate layer and the at least one thermoplastic continuous fiber layer comprises overlapping the thermoplastic discontinuous fiber aggregate layer and the two thermoplastic continuous fiber layer and performing a thermal compression such that the thermoplastic discontinuous fiber aggregate layer is clamped between the two thermoplastic continuous fiber layers.

3. The manufacturing method of the thermoplastic continuous-discontinuous fiber composite sheet of claim 1, wherein the step of thermally compressing the at least one thermoplastic discontinuous fiber aggregate layer and the at least one thermoplastic continuous fiber layer comprises overlapping the thermoplastic continuous fiber layer and the two thermoplastic discontinuous fiber aggregate layer and performing a thermal compression such that the thermoplastic continuous fiber layer is clamped between the two thermoplastic discontinuous fiber aggregate layers.

4. The manufacturing method of the thermoplastic continuous-discontinuous fiber composite sheet of claim 1, wherein the step of thermally compressing the at least one thermoplastic discontinuous fiber aggregate layer and the at least one thermoplastic continuous fiber layer comprises alternately overlapping the thermoplastic continuous fiber layer and the thermoplastic discontinuous fiber aggregate layer and performing a thermal compression.

5. The manufacturing method of the thermoplastic continuous-discontinuous fiber composite sheet of claim 1, further comprising, before the step of thermally compressing the at least one thermoplastic discontinuous fiber aggregate layer and the at least one thermoplastic continuous fiber layer, forming a strengthening layer on at least one surface of the thermoplastic discontinuous fiber aggregate layer, wherein the strengthening layer is at least located between the thermoplastic discontinuous fiber aggregate layer and the thermoplastic continuous fiber layer.

6. The manufacturing method of the thermoplastic continuous-discontinuous fiber composite sheet of claim 5, wherein the strengthening layer comprises a single film layer or is formed by a powder.

7. The manufacturing method of the thermoplastic continuous-discontinuous fiber composite sheet of claim 1, wherein a method of forming the thermoplastic discontinuous fiber aggregate layer comprises thermally compressing the plurality of fragments.

8. The manufacturing method of the thermoplastic continuous-discontinuous fiber composite sheet of claim 7, wherein a method of thermally compressing the plurality of fragments comprises molding or stamping.

9. The manufacturing method of the thermoplastic continuous-discontinuous fiber composite sheet of claim 1, wherein a method of forming the thermoplastic discontinuous fiber aggregate layer comprises mixing and granulating the plurality of fragments to form a plurality of particles and performing an injection molding using the plurality of particles.

10. The manufacturing method of the thermoplastic continuous-discontinuous fiber composite sheet of claim 1, wherein a method of thermally compressing the thermoplastic discontinuous fiber aggregate layer and the thermoplastic continuous fiber layer comprises performing a lamination using a flat film or a flat steel sheet.

11. The manufacturing method of the thermoplastic continuous-discontinuous fiber composite sheet of claim 1, wherein the continuous fiber in the thermoplastic composite comprises a carbon fiber, a glass fiber, a basalt fiber, a metal fiber, a ceramic fiber, or a chemical fiber.

12. The manufacturing method of the thermoplastic continuous-discontinuous fiber composite sheet of claim 1, wherein the first thermoplastic resin in the thermoplastic composite comprises a polycarbonate (PC), a polypropylene (PP), a polysulfone (PS), a thermoplastic polyurethane (TPU), an acrylonitrile butadiene styrene resin (ABS), a polyethylene (PE), a thermoplastic epoxy resin, a polyurethane resin, a polyurea resin, or a combination thereof.

13. The manufacturing method of the thermoplastic continuous-discontinuous fiber composite sheet of claim 5, wherein the strengthening layer comprises a second thermoplastic resin.

14. The manufacturing method of the thermoplastic continuous-discontinuous fiber composite sheet of claim 13, wherein the second thermoplastic resin comprises a PC, a PP, a PS, a TPU, an ABS resin, a PE, a thermoplastic epoxy resin, a polyurethane resin, a polyurea resin, or a combination thereof.

15. The manufacturing method of the thermoplastic continuous-discontinuous fiber composite sheet of claim 13, wherein the first thermoplastic resin is different from the second thermoplastic resin.

16. The manufacturing method of the thermoplastic continuous-discontinuous fiber composite sheet of claim 1, wherein a length of the discontinuous fiber is 3 mm to 20 mm.

17. The manufacturing method of the thermoplastic continuous-discontinuous fiber composite sheet of claim 1, wherein a length of the discontinuous fiber is less than 3 mm.

18. The manufacturing method of the thermoplastic continuous-discontinuous fiber composite sheet of claim 1, wherein a length of the discontinuous fiber is 20 mm to 50 mm.

19. The manufacturing method of the thermoplastic continuous-discontinuous fiber composite sheet of claim 1, wherein the thermoplastic resin is a recycled thermoplastic composite.
